(19) United States
(12) Patent Application Publication
(10) Pub. No.: US 2026/0195850 A1
(43) Pub. Date: Jul. 9, 2026

(54) METHOD FOR CONSTRUCTING A WHOLE PALMAR DACTYLOGRAM FROM PARTIAL PALMAR DACTYLOGRAMS

(71) Applicant: IDEMIA PUBLIC SECURITY FRANCE, Courbevoie (FR)

(72) Inventors: Emilie NIAF, Courbevoie (FR); Laurent KAZDAGHLI, Courbevoie (FR)

(73) Assignee: IDEMIA PUBLIC SECURITY FRANCE, Courbevoie (FR)

(21) Appl. No.: 19/346,727

(22) Filed: Oct. 1, 2025

(30) Foreign Application Priority Data
Jan. 3, 2025 (FR) FR2500032

(51) Int. Cl. G06T 3/4038; G06T 7/11; G06T 11/60; G06V 40/12

(52) U.S. Cl. CPC G06T 3/4038; G06T 7/11; G06T 11/60; G06V 40/1365; G06T 2200/32; G06T 2210/12

(57) ABSTRACT

A method for reconstructing a palmar dactylogram of an entirety of a palm of a hand, the method comprising (a) acquiring a partial palmar dactylogram of a region of the palm of a hand; (b) forming an intermediate reconstructed dactylogram by mosaicking the partial palmar dactylogram; (c) calculating a value of a quality criterion of the intermediate reconstructed dactylogram; (d) repeating the forming and calculating steps as long as the value of the quality criterion is less than a threshold value, in each iteration the partial palmar dactylogram acquired in the step acquiring being rejected; (e) determining at least one region among the regions of the palm of the hand not covered by the intermediate reconstructed dactylogram; and (f) repeating steps (a) to (e) and selecting, in the acquiring step, the region determined in the determining step, as long as the intermediate reconstructed dactylogram does not cover all of the regions of the palm of the hand.

### TECHNICAL FIELD

The present invention relates to a method for constructing a whole palmar dactylogram from partial palmar dactylograms.

### TECHNICAL BACKGROUND

Dactyloscopy is a method for identifying individuals which is based on the use of dactylograms, which are also known as “papillary prints”, papillary prints comprising “fingerprints” and “palm prints”. This method is particularly used by judicial anthropometry services or by civil identification systems during, for example, administrative procedures, when crossing borders or when accessing secure locations.

Dactylograms are patterns formed by the traces left on surfaces by the dermatoglyphics of the fingers and/or the palm of the hand. Dermatoglyphics are the superficial furrows formed on the palms, the soles and the tip of the fingers by the dermal ridges and arranged in lines or whorls. They are specific to each individual and the patterns which they form constitute an anthropometric “identity card” thereof by virtue of which they may be identified. Recording dactylograms is common practice in various administrative procedures in state institutions and in operations carried out by law enforcement agencies in relation to a suspect or to a defendant within the context of an infraction, an offence or a crime.

It is common to acquire a whole palmar dactylogram using devices equipped with an acquisition area allowing an entire palm of an individual to be acquired in a single acquisition, regardless of the size of the palm. However, such a device is bulky and not very transportable.

In practice, especially in the context of field activities, a smaller mobile device is preferable because it is more ergonomic. One example of a common type of mobile device are devices the dimensions of the acquisition area of which conform to the “FAP 60” standard (76 mm×81 mm). However, the average width of a palm of a male individual is 89 mm. Therefore, such a device cannot acquire the palmar print of the entirety of a palm in a single acquisition for the majority of individuals. One solution is to acquire partial palmar dactylograms and then reconstruct a whole palmar dactylogram using image processing.

EP 4 273 815 A1 [IDEMIA IDENTITY & SECURITY FRANCE [FR]] 08.11.2023 describes a method for constructing, by mosaicking, a dactylogram of the entirety of a palm from partial palmar dactylograms having overlapping areas.

### SUMMARY OF THE INVENTION

The completeness and quality of a reconstruction of a whole palmar dactylogram from partial palmar dactylograms is mainly based on the coverage of the palm that the partial palmar dactylograms are liable to allow when assembled. Faced with this problem, a human operator may encounter several obstacles, which are very frequently major. In particular, the number of images of partial dactylograms acquired may be insufficient to cover every relevant area of the palm. Furthermore, even if the operator increases the number of acquisitions, there is no guarantee that all of the palm will be correctly covered, and/or that the quality of the acquired partial dactylograms will be sufficient to allow them to be used. The result is a waste of time and a lack of operational efficiency.

A first aspect of the invention relates to a method 500 for reconstructing a palmar dactylogram of the entirety of a palm of a hand, the method comprising the following steps:
(a) acquiring 501 a partial palmar dactylogram of a region of the palm of a hand;
(b) forming 502 an intermediate reconstructed dactylogram by mosaicking the partial palmar dactylogram;
(c) calculating 503 the value of a quality criterion of the intermediate reconstructed dactylogram;
(d) repeating 504 steps 502 to 503 as long as the value of the quality criterion is less than a threshold value, in each iteration the partial palmar dactylogram acquired in step 501 being rejected;
(e) determining 505 at least one region among the regions of the palm of the hand not covered by the intermediate reconstructed dactylogram;
(f) repeating 506 steps 501 to 505 with selection, in step 501, of the region determined in step 505, as long as the intermediate reconstructed dactylogram does not cover all of the regions of the palm of the hand.

According to certain embodiments, step 505 comprises a step 505a of determining a bounding box the geometric dimensions of which correspond to those of a size of a whole palm, said size being estimated from the intermediate reconstructed dactylogram.

According to certain embodiments, the parameters of the bounding box comprise the centre of the bounding box, an orientation vector, a width, a height and a class among the right hand and left hand.

According to certain embodiments, the bounding box is determined using a convolutional neural network.

According to certain embodiments, the method 500 comprises, before step 505, a step 505a of determining a graphic mask of the intermediate reconstructed dactylogram, and, in step 505, a step of superposing the graphic mask and the bounding box, the region not covered by the intermediate reconstructed dactylogram being the region of the bounding box not covered by the graphic mask.

According to certain embodiments, the bounding box comprises five regions among an upper part of the palm, a lower part of the palm, a left part of the palm, a right part of the palm and a centre of the palm.

According to certain embodiments, the quality criterion is an average value of the gradient of the intermediate reconstructed dactylogram.

A second aspect of the invention relates to a system for acquiring a palmar dactylogram of the entirety of a palm of a hand, the system comprising:
a mobile device for acquiring palmar dactylograms;
a data-processing device configured to receive partial palmar dactylograms from the mobile acquiring device, and comprising means for implementing a reconstructing method 500 according to any of the embodiments.

According to certain embodiments, the system further comprises a displaying device configured to display the intermediate reconstructed dactylogram, and the region of the palm of the hand not covered by the intermediate reconstructed dactylogram and selected in step 506 of the reconstructing method 500 according to the first aspect of the invention.

### BRIEF DESCRIPTION OF THE DRAWINGS

FIG. 1 is a schematic representation of a dactylogram-acquiring device.

FIG. 2 is a schematic representation of a palm of a hand divided into a plurality of regions.

FIG. 3 is one example of a partial palmar dactylogram covering part of the palm of a hand.

FIG. 4 is a schematic representation of an intermediate palmar dactylogram reconstructed from three partial palmar dactylograms.

FIG. 5 is a flowchart of a method for reconstructing a whole palmar dactylogram according to the first aspect of the invention.

FIG. 6 is a schematic representation of a bounding box estimated from an intermediate reconstructed palmar dactylogram.

FIG. 7 is a schematic representation of a graphic mask of an intermediate reconstructed palmar dactylogram.

### DETAILED DESCRIPTION OF THE EMBODIMENTS

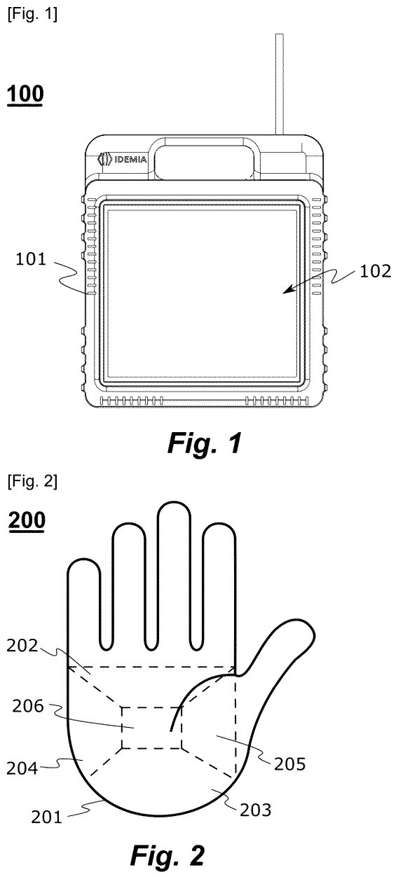

With reference to FIG. 1, a mobile device 100 for acquiring dactylograms is, for example, a device of small dimensions, generally conforming to the FAP 60 standard, comprising an electronic housing 101 and an acquisition area 102 of 76×81 mm size, on which only part of a hand can be placed to acquire an image of its dermatoglyphics. Such an acquisition area 102 does not allow a dactylogram of the entirety of a palm to be acquired in a single acquisition for a vast majority of individuals. The dactylograms acquired by the device 100 generally take the form of an image of the patterns formed by the dermatoglyphics. These images may be single-channel images, for example a greyscale image, or multi-channel images, for example RGB images.

With reference to FIG. 2, the palm 201 of a hand 200 may be divided into a plurality of regions 202-206. The number, shape and location of the regions 202 are chosen in accordance with practices and protocols defined by the administrative and judicial institutions of the state in question. In practice, it is, for example, possible to define five regions 202-206 among an upper part 202 of the palm 201, a lower part 203 of the palm 201, a left part 204 of the palm 201, a right part 205 of the palm 201 and a centre 206 of the palm 201.

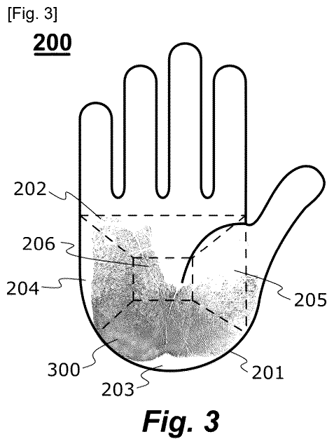

A partial palmar dactylogram capable of being acquired using a mobile device 100 such as described above may cover all or part of one or more regions 202-206 of the palm 201 of the hand 200. For example, with reference to FIG. 3, a partial palmar dactylogram 300 may cover the left part 204 of the palm 201 and the lower part 203 of the palm 201.

A dactylogram of the entirety of a palm of a hand may be reconstructed or re-created from a plurality of partial palm dactylograms using image processing, and generally by mosaicking. This image processing generally consists in identifying common morphological features shared by overlapping areas of partial palmar dactylograms and then determining, on the basis of these common morphological features, one or more geometrical transformations that when applied to the partial palmar dactylograms make it possible to construct a mosaic in which said dactylograms are used as tesserae. EP 4 273 815 A1 [IDEMIA IDENTITY & SECURITY FRANCE [FR]] 08.11.2023 describes one example of a method for reconstructing a dactylogram of the entirety of a palm from partial palmar dactylograms.

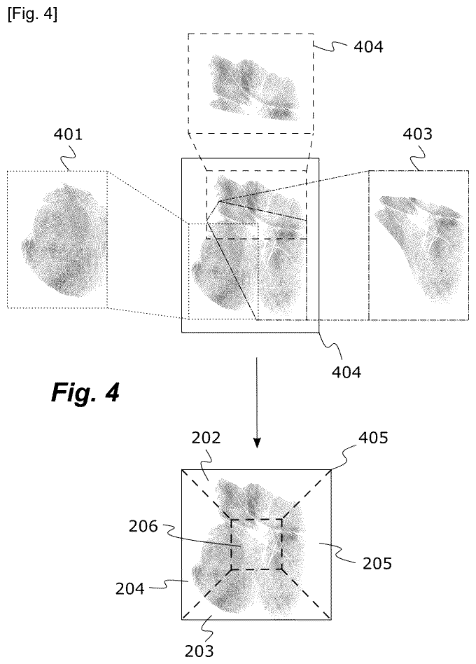

The reconstruction of a dactylogram of the entirety of a palm from partial palmar dactylograms is generally carried out via successive steps of mosaicking each partial palmar dactylogram to form a complete reconstructed dactylogram. By way of illustrative example, with reference to FIG. 4, two partial palmar dactylograms 401, 402 are first “combined” to form an intermediate reconstructed dactylogram 404. Next, each other partial palmar dactylogram 403 is successively combined with the intermediate reconstructed dactylogram 404 until all of the regions 202-206 of the palm 201 are covered to form a complete reconstructed dactylogram 405.

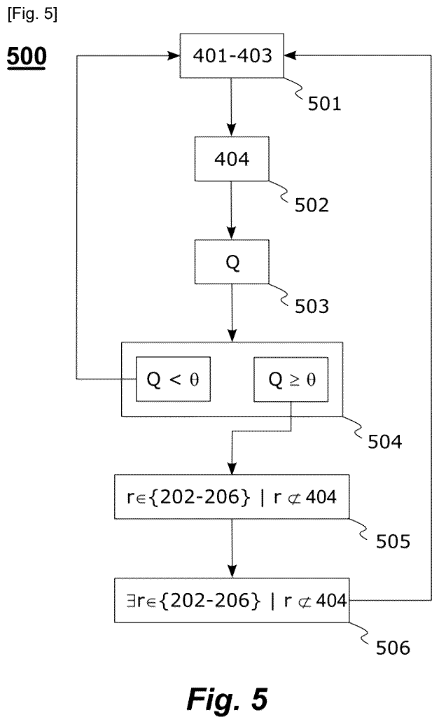

With reference to FIG. 5, a first aspect of the invention relates to a method 500 for reconstructing a palmar dactylogram of the entirety of a palm 201 of a hand 200, the method comprising the following steps:
(a) acquiring 501 a partial palmar dactylogram 401-403 of a region 202-206 of the palm 201 of a hand 200;
(b) forming 502 an intermediate reconstructed dactylogram 404 by mosaicking the partial palmar dactylogram 401-403;
(c) calculating 503 the value of a quality criterion Q of the intermediate reconstructed dactylogram 404;
(d) repeating 504 steps 502 to 503 as long as the value of the quality criterion Q is less than a threshold value θ, in each iteration the partial palmar dactylogram 401-403 acquired in step 501 being rejected;
(e) determining 505 at least one region R among the regions 202-206 of the palm 201 of the hand 200 not covered by the intermediate reconstructed dactylogram 404;
(f) repeating 506 steps 501 to 505 with selection, in step 501, of the region R determined in step 505, as long as the intermediate reconstructed dactylogram 404 does not cover all of the regions 202-206 of the palm 201 of the hand 200.

In step 502, the intermediate reconstructed dactylogram 404 is a reconstruction from at least one partial palmar dactylogram 401-403. In particular, in the first iteration of the method 500 according to the invention, the intermediate reconstructed dactylogram 404 consists of all or part of a first partial palmar dactylogram 401-403 acquired in step 501. During the following iterations, all or part of a plurality of partial palmar dactylograms 401-403 are gradually added as they are acquired. The intermediate reconstructed dactylogram 404 is formed using any suitable method. One example of a reconstructing method is described in EP 4 273 815 A1 [IDEMIA IDENTITY & SECURITY FRANCE [FR]] 08.11.2023.

In step 503, the quality criterion Q makes it possible to evaluate the quality of the intermediate reconstructed dactylogram 404, particularly if the contrast between the furrows and the papillary ridges of the dactylogram is sufficient to allow identification and characterization of morphological characteristics, such as minutiae, of said dactylogram 404. In practice, it is an indicator of the tendency of the palm 201 of the hand 200 to leave a papillary trace on a surface.

The tendency of a palm 201 of a hand 200 to leave a papillary trace on a surface or to allow a palmar dactylogram thereof to be acquired is generally dependent on the amount of epidermal oil present on the surface of the stratum corneum of its epidermis. If this amount is insufficient, the palm 201 of the hand 200 then being said to be “dry”, the amplitude of the variations in indices of refraction or reflection between the papillary valleys and ridges will be too small. A dactylogram acquired using an optical device such as illustrated in FIG. 1 will be of insufficient contrast to allow the morphological features of the dermatoglyphics to be correctly distinguished. In contrast, if this amount is sufficient, the palm 201 of the hand 200 then being said to be “oily”, the amplitude of the variations in indices of refraction or reflection between the papillary valleys and ridges will allow a dactylogram of sufficient contrast to be obtained. When a palm 201 of a hand 200 is too dry, it is possible to moisten it, using a wipe or a suitable sponge, in order to improve the contrast during the acquisition of the dactylogram.

The quality criterion Q is of any suitable type. Examples of quality criteria, and of the methods used to determine them, are described in Alonso-Fernandez et al. (2007). A Comparative Study of Fingerprint Image-Quality Estimation Methods. IEEE Transactions on Information Forensics and Security, 2(4), 734-743. According to one preferred embodiment, the quality criterion Q is an average value of the gradient of the intermediate reconstructed dactylogram 404.

The threshold value e of the quality criterion Q depends on the method used to assess it and on the degree of accuracy required by the operator or administration in question. By way of practical example, when the quality criterion Q is an average value, between 0 and 1, of the gradient of the intermediate reconstructed dactylogram 406, the threshold value e may be set to 0.90, or even 0.95. When the value of the quality criterion Q is less than the threshold value, the contrast between the papillary valleys and ridges of the intermediate reconstructed dactylogram 404 is considered to be insufficient. The method 500 may then further make provision, using a display screen, for a notification step prompting the user to moisten the palm 201 of their hand 200 before performing a new acquisition of a partial palmar dactylogram 401-403.

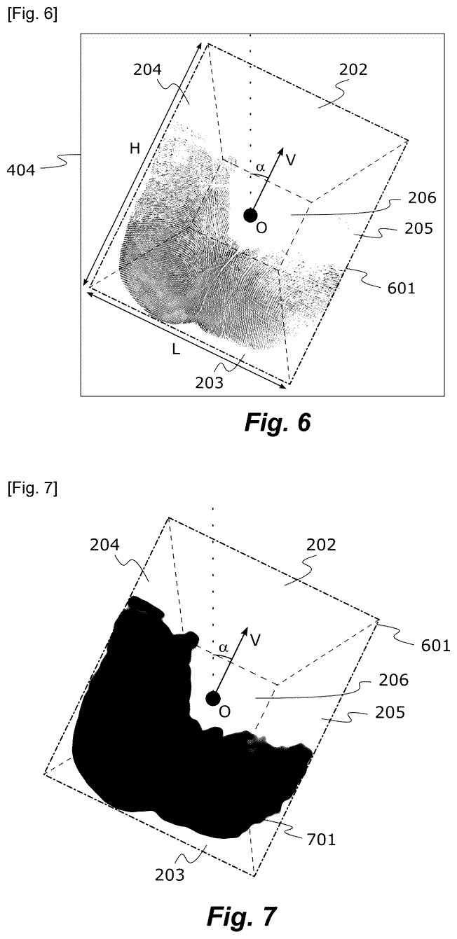

According to certain embodiments, with reference to FIG. 6, step 505 comprises a step 505a of determining a bounding box 601 the geometric dimensions H, L of which correspond to those of a size of a whole palm 201, said size being estimated from the intermediate reconstructed dactylogram 404. In FIG. 6, the bounding box 601 is a rectangle (represented by a dash-dotted line) the lengths H, L of the sides of which are such that said sides bound the entirety of the palm 201 that the hand 200 should have according to the dimensions of the intermediate reconstructed dactylogram 404.

The bounding box 601 makes it possible to define the borders of the entirety of the palm 201 of the hand 200, even when the intermediate reconstructed dactylogram 404 is incomplete. It is considered to be a schematic representation of the palm 201 of the hand 200, and can be divided into the same regions 202-206 as the palm 201. By virtue of this bounding box 601 and its division into regions 202-206, a degree of coverage of the area of said box 601 by the intermediate reconstructed dactylogram 404 may be calculated. This degree of coverage reveals the one or more regions 202-206 of the palm 201 not covered by said intermediate reconstructed dactylogram 404.

According to certain embodiments, the parameters of the bounding box 601 comprise the centre O of the bounding box 601, an orientation vector V, a width L, a height H and a class C among the right hand and left hand. The orientation vector V and the class C among the right hand and left hand make it possible to determine the actual orientation of the palm 201, and particularly make it possible to differentiate between the lower part and the upper part of the palm, and the right part and the left part of the palm. Thus, it is possible to accurately determine, on the palm 201, the location of any regions 202-206 not covered by the intermediate reconstructed dactylogram 404. On the basis of this information, the method may further make provision, using a display screen, for a notification step informing which part of the palm 201 of the hand 200 must be placed on the acquisition area 102 of the acquiring device 100 to complete the regions of the intermediate reconstructed dactylogram 404 that are not covered.

The bounding box 601 is determined using any suitable method. Preferably, it is determined using a convolutional neural network such as the YOLO network described in Redmon, J. (2016). You Only Look Once: Unified, Real-Time Object Detection. In Proceedings of the IEEE Conference on Computer Vision and Pattern Recognition, in particular the YOLOv7 network described in Wang et al. (2023). YOLOv7: Trainable bag-of-freebies sets new state-of-the-art for real-time object detectors In Proceedings of the IEEE/CVF Conference on Computer Vision and Pattern Recognition (pp. 7464-7475).

The convolutional neural network is trained using any suitable method. According to one example in which the convolutional neural network is a YOLOv7 network, it may be trained on a set of whole and/or partial palm dactylograms annotated with bounding boxes the parameters of which comprise the centre of the bounding box, an orientation vector, a width, a height and a class among the right hand and the left hand. To diversify the training data, data-augmentation methods such as rotating and/or resizing the dactylograms, masking parts of the dactylograms, adding noise (Gaussian noise for example), inversion operations and/or offset operations, may advantageously be used.

Advantageously, a cross-entropy loss function may be used to train the convolutional neural network on the training set. In particular, the loss function may be the sum of three cross-entropy loss functions:

$$f = \sum ( {L}_{o} + {L}_{c} + {L}_{b} )$$

Lₒ is a cross-entropy loss function corresponding to the presence or absence of a bounding box; L_{c} is a cross-entropy loss function corresponding to the right or left class of dactylogram; and L_{b} is a distance function combining measurements of intersection over union (IoU), Manhattan distance (L1) and Euclidean regularization (L2) allowing the parameters (dimension, orientation) of the bounding box to be determined. In the function L_{b}, the parameters corresponding to the orientation vector V are expressed using one or more trigonometric functions of an angle α of inclination of a direction representative of the bounding box to a reference direction.

According to certain embodiments, with reference to FIG. 7, the method 500 comprises, before step 505, a step 505a of determining a graphic mask 701 of the intermediate reconstructed dactylogram 404, and, in step 505, a step of superposing the graphic mask 701 and the bounding box 601, the region R not covered by the intermediate reconstructed dactylogram 404 being the region of the bounding box 601 not covered by the graphic mask 701.

The graphic mask 701 is a simplified representation of the area of the palm 201 of the hand 200 covered by the intermediate reconstructed dactylogram 404. In other words, it represents the area of the regions 202-206 of the palm 201 of the hand 200 for which a dactylogram is available. In the example shown in FIG. 7, the graphic mask 701 covers regions 203 and 204; regions 202, 205 and 206 are not covered. In step 506, one of these three regions 202, 205, 206 may be selected for the next iteration of steps 501 to 505 of the method 500. All of the regions 202-206 of the bounding box 601 are considered to be covered by the graphic mask 701 when, for example, the Jaccard index between the areas of the bounding box 601 and graphic mask 701 tends towards unity, or indeed is greater than a threshold value, for example 0.80 or even 0.90 or indeed 0.95. A region 202-206 is considered to be covered by the graphic mask 701 when the Jaccard ratio for this region 202-206, i.e. between said region 202-206 and the graphic mask 701, tends towards unity, or indeed is greater than a threshold value, for example 0.80 or even 0.90 or indeed 0.95.

The graphic mask may be obtained by segmenting the intermediate reconstructed dactylogram 404. It may then be a binary image the 0 and 1 values of which represent the intermediate reconstructed dactylogram 406, and the values 1 and 0 of which represent the background, respectively. Examples of segmentation are: watershed; the mask R-CNN as described in He, et al. (2017). Mask R-CNN. In Proceedings of the IEEE International Conference on Computer Vision, p. 2961-2969; and GrabCut as described in Rother et al. (2004). “GrabCut” interactive foreground extraction using iterated graph cuts. ACM Transactions on Graphics (TOG), 23(3), 309-314.

As explained above, the palm 201 of a hand 200 can be divided into a plurality of regions 202-206. The bounding box 601 may be considered to be an intermediary providing a simplified geometric representation of the palm 201 of the hand 200, particularly of rectangular shape. Its area may then be subdivided into a plurality of regions 202-206 schematically representing the regions 202-206 of the palm 201 of the hand 200. Superposition of the graphic mask 701 and of the bounding box 601 then makes it possible to detect regions 202-206 of the bounding box 601 not covered by said graphic mask 701, and therefore, by the intermediate reconstructed dactylogram 404. In step 506 of the method 500, a region R of the palm 201 of the hand 200 may then be selected from these regions 202-206 that are not covered.

A second aspect of the invention relates to a system for acquiring a palmar dactylogram of the entirety of a palm 201 of a hand 200, the system comprising:
a mobile device 100 for acquiring palmar dactylograms;
a data-processing device configured to receive partial palmar dactylograms from the mobile acquiring device 100, and comprising means for implementing a reconstructing method 500 according to any one of the embodiments of the first aspect of the invention.

The processing device is responsible for automatically executing sequences of arithmetic or logic operations in order to perform tasks or actions. The device, commonly referred to as a computer, may comprise one or more central processing units (CPUs) and/or one or more graphics processing units (GPUs), a physical remote communication module, one or more physical input/output modules for interchanging data with external devices, a transient storage medium such as a random access memory (RAM), a non-transient recording medium and communication buses (not shown) for transferring data between the internal components of the device.

The data-processing device makes it possible to execute one or more program modules comprising instructions that, when the one or more program modules are executed, cause said device to execute the method 500 of the first aspect of the invention. The program module or modules may be written in any, compiled or interpreted, programming language. They may form part of a software solution, i.e. of a collection of executable instructions, of codes, of scripts or the like and/or of databases.

The data-processing device may form an integral part of the mobile device 100 for acquiring palmar dactylograms. In particular, it may be the control circuit board of the mobile acquiring device 100.

Alternatively, the data-processing device may be an external element, such as a laptop or mobile electronic device, for example a touchscreen tablet, in wired or wireless communication with the mobile device 100 for acquiring palmar dactylograms.

According to certain embodiments, the system further comprises a displaying device configured to display the intermediate reconstructed dactylogram 404, and the region R of the palm 201 of the hand 200 not covered by the intermediate reconstructed dactylogram 404 and selected in step 506 of the method 500 of the first aspect of the invention, and/or notifications such as those described above intended for the user of the system. The displaying device may be a screen integrated into the data-processing device or mobile acquiring device 100.

### REFERENCES

### Patent Literature

EP 4 273 815 A1 [IDEMIA IDENTITY & SECURITY FRANCE [FR]] 08.11.2023.

### Non-Patent Literature

Rother et al. (2004). “GrabCut” interactive foreground extraction using iterated graph cuts. ACM Transactions on Graphics (TOG), 23(3), 309-314.
Alonso-Fernandez et al. (2007). A Comparative Study of Fingerprint Image-Quality Estimation Methods. IEEE Transactions on Information Forensics and Security, 2(4), 734-743.
Redmon et al. (2016). You Only Look Once: Unified, Real-Time Object Detection. In Proceedings of the IEEE Conference on Computer Vision and Pattern Recognition.
He, et al. (2017). Mask R-CNN. In Proceedings of the IEEE International Conference on Computer Vision, p. 2961-2969.
Wang et al. (2023). YOLOv7: Trainable bag-of-freebies sets new state-of-the-art for real-time object detectors In Proceedings of the IEEE/CVF Conference on Computer Vision and Pattern Recognition (pp. 7464-7475).

1. A method for reconstructing a palmar dactylogram of an entirety of a palm of a hand, the method comprising:
acquiring a partial palmar dactylogram of a region of the palm of a hand;
forming an intermediate reconstructed dactylogram by mosaicking the partial palmar dactylogram;
calculating a value of a quality criterion of the intermediate reconstructed dactylogram;
repeating the forming and calculating steps as long as the value of the quality criterion is less than a threshold value, in each iteration the partial palmar dactylogram acquired in the acquiring step being rejected;
determining a region among regions of the palm of the hand not covered by the intermediate reconstructed dactylogram; and
repeating steps (a)-(e) and selecting, in the acquiring step, the region determined in the determining step, as long as the intermediate reconstructed dactylogram does not cover all of the regions of the palm of the hand.

2. The method according to claim 1, wherein the determining step further comprises determining a bounding box, the geometric dimensions of which correspond to those of a size of a whole palm, said size being estimated from the intermediate reconstructed dactylogram.

3. The method according to claim 2, wherein the parameters of the bounding box comprise the center of the bounding box, an orientation vector, a width, a height and a class among the right hand and left hand.

4. The method according to claim 2, wherein the bounding box is determined using a convolutional neural network.

5. The method according to claim 2, further comprising, before the determining step, determining a graphic mask of the intermediate reconstructed dactylogram, and, in the determining step, superposing the graphic mask and the bounding box, the region not covered by the intermediate reconstructed dactylogram being the region of the bounding box not covered by the graphic mask.

6. The method according to claim 2, wherein the bounding box comprises five regions among an upper part of the palm, a lower part of the palm, a left part of the palm, a right part of the palm and a center of the palm.

7. The method according to claim 1, wherein the quality criterion is an average value of the gradient of the intermediate reconstructed dactylogram.

8. A system for acquiring a palmar dactylogram of the entirety of the palm of the hand, the system comprising:
a mobile device configured to acquire palmar dactylograms;
a data-processing device configured to receive partial palmar dactylograms from the mobile acquiring device, and comprising means for implementing a reconstructing method according to claim 1.

9. The system according to claim 8, further comprises comprising a displaying device configured to display the intermediate reconstructed dactylogram, and the region of the palm of the hand not covered by the intermediate reconstructed dactylogram and selected in the selecting step.

10. The system according to claim 8, wherein the determining step further comprises determining a bounding box, geometric dimensions of which correspond to those of a size of a whole palm, said size being estimated from the intermediate reconstructed dactylogram.

11. The system according to claim 10, wherein the parameters of the bounding box comprise the center of the bounding box, an orientation vector, a width, a height and a class among the right hand and left hand.

12. The system according to claim 10, wherein the bounding box is determined using a convolutional neural network.

13. The system according to claim 10, further comprising, before the determining step, a step of determining a graphic mask of the intermediate reconstructed dactylogram, and, in the determining step, superposing the graphic mask and the bounding box, the region not covered by the intermediate reconstructed dactylogram being the region of the bounding box not covered by the graphic mask.

14. The system according to claim 10, wherein the bounding box comprises five regions among an upper part of the palm, a lower part of the palm, a left part of the palm, a right part of the palm and a center of the palm.

15. The system according to claim 8, wherein the quality criterion is an average value of the gradient of the intermediate reconstructed dactylogram.

16. A non-transitory computer-readable medium storing a program that, when executed by processing circuitry, causes the processing circuitry to perform a method for reconstructing a palmar dactylogram of an entirety of a palm of a hand, the method comprising:
(a) acquiring a partial palmar dactylogram of a region of the palm of a hand;
(b) forming an intermediate reconstructed dactylogram by mosaicking the partial palmar dactylogram;
(c) calculating a value of a quality criterion of the intermediate reconstructed dactylogram;
(d) repeating the forming and calculating steps as long as the value of the quality criterion is less than a threshold value, in each iteration the partial palmar dactylogram acquired in the acquiring step being rejected;
(e) determining a region among regions of the palm of the hand not covered by the intermediate reconstructed dactylogram; and
(f) repeating steps (a)-(e) and selecting, in the acquiring step, the region determined in the determining step, as long as the intermediate reconstructed dactylogram does not cover all of the regions of the palm of the hand.

17. The computer-readable medium according to claim 16, wherein the determining step further comprises determining a bounding box, geometric dimensions of which correspond to those of a size of a whole palm, said size being estimated from the intermediate reconstructed dactylogram.

18. The computer-readable medium according to claim 17, wherein the parameters of the bounding box comprise the center of the bounding box, an orientation vector, a width, a height and a class among the right hand and left hand.

19. The computer-readable medium according to claim 17, wherein the bounding box is determined using a convolutional neural network.

20. The computer-readable medium according to claim 17, further comprising, before the determining step, a step of determining a graphic mask of the intermediate reconstructed dactylogram, and, in the determining step, superposing the graphic mask and the bounding box, the region not covered by the intermediate reconstructed dactylogram being the region of the bounding box not covered by the graphic mask.
